(19) United States
(12) Patent Application Publication
(10) Pub. No.: US 2025/0063607 A1
(43) Pub. Date: Feb. 20, 2025

(54) DETERMINISTIC BACKOFF PERIODS FOR WIRELESS TRANSMISSIONS

(71) Applicant: QUALCOMM Incorporated, San Diego, CA (US)

(72) Inventor: Maarten Menzo WENTINK, Nijmegen (NL)

(21) Appl. No.: 18/452,251

(22) Filed: Aug. 18, 2023

(51) Int. Cl. H04W 74/08

(52) U.S. Cl. CPC H04W 74/085; H04W 74/0875

(57) ABSTRACT

This disclosure provides methods, components, devices and systems for backoff periods. In some approaches, channel access for wireless devices may be prioritized. For example, some types of data traffic or wireless devices may have associated priorities, and channel access may be managed based on the associated priorities. In some approaches, a wireless device may utilize a backoff value associated with a priority to manage a backoff period. In some approaches, a randomized backoff may be utilized based on a random value within a random range and an offset value. For example, a random backoff may be increased in a case that a threshold quantity of collisions occurred at a deterministic backoff node. A fixed block size offset may be added to the random backoff.

### TECHNICAL FIELD

This disclosure relates to wireless communication and, more specifically, to backoff periods.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, STAs utilize contention-based access to share the wireless communication medium. Some contention-based access schemes may suffer from jitter or channel access delays.

### SUMMARY

The systems, methods, and devices of this disclosure each have several innovative aspects, no single one of which is solely responsible for the desirable attributes disclosed herein. In some cases, multiple wireless devices may share a wireless channel. To manage shared access to the wireless channel, some wireless devices employ a contention window (CW) with backoff. A contention window may be a range within which a backoff counter may be selected. During a backoff period, a wireless device may monitor the wireless channel for activity (for example, transmissions from other wireless devices). For instance, the wireless device may utilize the backoff counter to count a quantity of idle time slots. If the backoff counter satisfies a threshold, the wireless device may transmit on the wireless channel. When a collision occurs (for example, when multiple wireless devices transmit concurrently), a wireless device may adjust the CW, select another backoff counter, or a combination thereof to attempt to access the wireless channel at a later time.

Different wireless devices may utilize different channel access procedures or may communicate different types of data traffic. Some scenarios may lead to different channel access delays for some wireless devices or may lead to channel congestion where traffic that is less time sensitive may have similar (or even reduced) channel access delays than traffic that is more time sensitive. Some of the approaches disclosed herein may address these situations by prioritizing channel access, adjusting a CW, adjusting a backoff, or a combination thereof.

In some approaches, channel access for wireless devices may be prioritized. For example, some types of data traffic or wireless devices may have associated priorities, and channel access may be managed based on the associated priorities. Priority differentiation may be achieved by adjusting a fixed offset in a target CW. For example, a CW may be adjusted based on a ratio of priorities. In some approaches, a wireless device with a higher priority may access a transmission medium more frequently than a wireless device with a lower priority.

In some approaches, a random backoff may be adjusted (for example, increased) in a case that a threshold quantity of collisions occurred at a deterministic backoff node. The random backoff may remain relatively small in this case, and a fixed block size offset may be added to the random backoff. The fixed offset may be increased as a function of the quantity of consecutive collisions. The increase may be linear or exponential, or may follow another curve as a function of a quantity of repeated colliding transmissions. In some implementations, the offset may be capped at a maximum value.

A method by a first wireless device is described. The method may include monitoring a wireless channel during a first deterministic backoff period to identify a first quantity of zero or more interrupting signals, transmitting, after the first deterministic backoff period, a first signal, the first signal followed by a second deterministic backoff period that is based on the first quantity of the zero or more interrupting signals and a first backoff value associated with a first priority, where the first backoff value is based on a default backoff value, the default backoff value being associated with a default priority, and transmitting a second signal after the second deterministic backoff period.

A first wireless device is described. The first wireless device may include a processing system that includes processor circuitry and memory circuitry that stores code. The processing system may be configured to cause the first wireless device to monitor a wireless channel during a first deterministic backoff period to identify a first quantity of zero or more interrupting signals, transmit, after the first deterministic backoff period, a first signal, the first signal followed by a second deterministic backoff period that is based on the first quantity of the zero or more interrupting signals and a first backoff value associated with a first priority, where the first backoff value is based on a default backoff value, the default backoff value being associated with a default priority, and transmit a second signal after the second deterministic backoff period.

Another first wireless device is described. The first wireless device may include means for monitoring a wireless channel during a first deterministic backoff period to identify a first quantity of zero or more interrupting signals, means for transmitting, after the first deterministic backoff period, a first signal, the first signal followed by a second deterministic backoff period that is based on the first quantity of the zero or more interrupting signals and a first backoff value associated with a first priority, where the first backoff value is based on a default backoff value, the default backoff value being associated with a default priority, and means for transmitting a second signal after the second deterministic backoff period.

A non-transitory computer-readable medium storing code is described. The code may include instructions executable by a processor to monitor a wireless channel during a first deterministic backoff period to identify a first quantity of zero or more interrupting signals, transmit, after the first deterministic backoff period, a first signal, the first signal followed by a second deterministic backoff period that is based on the first quantity of the zero or more interrupting signals and a first backoff value associated with a first priority, where the first backoff value is based on a default backoff value, the default backoff value being associated with a default priority, and transmit a second signal after the second deterministic backoff period.

In some implementations of the method, first wireless devices, and non-transitory computer-readable medium described herein, a first signal period that includes the first signal includes one or more transmissions by the first wireless device and zero or more transmissions by zero or more responding wireless devices, and a pair of transmissions may be separated by a short interframe space (SIFS) or a point coordination function (PCF) interframe space (PIFS).

Some implementations of the method, first wireless devices, and non-transitory computer-readable medium described herein may further include operations. features, means, or instructions for transmitting a third signal after a randomized backoff period and before the first deterministic backoff period, the randomized backoff period being based on detecting a collision pattern including one or more successful transmissions between colliding transmissions, and the monitoring being performed in response to a successful transmission of the third signal.

In some implementations of the method, first wireless devices, and non-transitory computer-readable medium described herein, the first backoff value may be a multiple of the default backoff value or a divisor of the default backoff value.

Some implementations of the method, first wireless devices, and non-transitory computer-readable medium described herein may further include operations, features, means, or instructions for transmitting a set of multiple signals periodically after the second signal in accordance with a ratio between the first priority and the default priority.

In some implementations of the method, first wireless devices, and non-transitory computer-readable medium described herein, the zero or more interrupting signals may be respectively transmitted by one or more second wireless devices of a set of wireless devices, each of the one or more second wireless devices transmits in accordance with one or more respective second backoff values associated with one or more respective priorities, and a transmission cycle of the set of wireless devices may be based on the first backoff value and one or more ratios of the first backoff value to the one or more respective second backoff values.

In some implementations of the method, first wireless devices, and non-transitory computer-readable medium described herein, the first backoff value and the default backoff value may be included in a set of backoff values and each backoff value may be a divisor of a greatest backoff value included in the set of backoff values.

In some implementations of the method, first wireless devices, and non-transitory computer-readable medium described herein, the first backoff value and the default backoff value may be included in a set of backoff values and each backoff value may be a multiple of a smallest backoff value included in the set of backoff values.

In some implementations of the method, first wireless devices, and non-transitory computer-readable medium described herein, the first backoff value and the default backoff value may be included in a set of backoff values and each backoff value except a smallest backoff value may be a multiple of a next smaller backoff value included in the set of backoff values.

Some implementations of the method, first wireless devices, and non-transitory computer-readable medium described herein may further include operations, features, means, or instructions for detecting a collision pattern based on a threshold of a quantity of repeated colliding transmissions and transmitting a third signal after a randomized backoff period and before the first deterministic backoff period in response to detecting the collision pattern.

In some implementations of the method, first wireless devices, and non-transitory computer-readable medium described herein, the randomized backoff period may be based on a random value within a random range and an offset value.

In some implementations of the method, first wireless devices, and non-transitory computer-readable medium described herein, the offset value may be determined in accordance with a function that increases with the quantity of repeated colliding transmissions.

In some implementations of the method, first wireless devices, and non-transitory computer-readable medium described herein, the function includes a block size value, indicating a quantity of time for increasing the first backoff value, multiplied by a difference between the quantity of repeated colliding transmissions and a minimum quantity of repeated colliding transmissions to trigger the randomized backoff period.

In some implementations of the method, first wireless devices, and non-transitory computer-readable medium described herein, the block size value may be a random quantity within a range that increases with the quantity of repeated colliding transmissions.

In some implementations of the method, first wireless devices, and non-transitory computer-readable medium described herein, the function increases linearly, increases exponentially, may be limited to a range within a maximum value, or a combination thereof.

A method by a first wireless device is described. The method may include monitoring a wireless channel to detect a collision pattern, transmitting a first signal after a randomized backoff period in response to detecting the collision pattern, the randomized backoff period being based on a random value within a random range and an offset value, monitoring the wireless channel during a first deterministic backoff period after the first signal to identify a first quantity of zero or more interrupting signals, transmitting, after the first deterministic backoff period, a second signal, the second signal followed by a second deterministic backoff period that is based on the first quantity of the zero or more interrupting signals and a first backoff value, and transmitting a third signal after the second deterministic backoff period.

A first wireless device is described. The first wireless device may include a processing system that includes processor circuitry and memory circuitry that stores code. The processing system may be configured to cause the first wireless device to monitor a wireless channel to detect a collision pattern, transmit a first signal after a randomized backoff period in response to detecting the collision pattern, the randomized backoff period being based on a random value within a random range and an offset value, monitor the wireless channel during a first deterministic backoff period after the first signal to identify a first quantity of zero or more interrupting signals, transmit, after the first deterministic backoff period, a second signal, the second signal followed by a second deterministic backoff period that is based on the first quantity of the zero or more interrupting signals and a first backoff value, and transmit a third signal after the second deterministic backoff period.

Another first wireless device is described. The first wireless device may include means for monitoring a wireless channel to detect a collision pattern, means for transmitting a first signal after a randomized backoff period in response to detecting the collision pattern, the randomized backoff period being based on a random value within a random range and an offset value, means for monitoring the wireless channel during a first deterministic backoff period after the first signal to identify a first quantity of zero or more interrupting signals, means for transmitting, after the first deterministic backoff period, a second signal, the second signal followed by a second deterministic backoff period that is based on the first quantity of the zero or more interrupting signals and a first backoff value, and means for transmitting a third signal after the second deterministic backoff period.

A non-transitory computer-readable medium storing code is described. The code may include instructions executable by a processor to monitor a wireless channel to detect a collision pattern, transmit a first signal after a randomized backoff period in response to detecting the collision pattern, the randomized backoff period being based on a random value within a random range and an offset value, monitor the wireless channel during a first deterministic backoff period after the first signal to identify a first quantity of zero or more interrupting signals, transmit, after the first deterministic backoff period, a second signal, the second signal followed by a second deterministic backoff period that is based on the first quantity of the zero or more interrupting signals and a first backoff value, and transmit a third signal after the second deterministic backoff period.

Some implementations of the method, first wireless devices, and non-transitory computer-readable medium described herein may further include operations, features, means, or instructions for detecting the collision pattern based on a threshold of a quantity of repeated colliding transmissions.

In some implementations of the method, first wireless devices, and non-transitory computer-readable medium described herein, the offset value may be determined in accordance with a function that increases with the quantity of repeated colliding transmissions.

In some implementations of the method, first wireless devices, and non-transitory computer-readable medium described herein, the function includes a block size value, indicating a quantity of time for increasing the first backoff value, multiplied by a difference between the quantity of repeated colliding transmissions and a minimum quantity of colliding transmissions to trigger the randomized backoff period.

In some implementations of the method, first wireless devices, and non-transitory computer-readable medium described herein, the block size value may be a random quantity within a range that increases with the quantity of colliding transmissions.

In some implementations of the method, first wireless devices, and non-transitory computer-readable medium described herein, the function increases linearly, increases exponentially, may be limited to a range within a maximum value, or a combination thereof.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a hierarchical format of an example PPDU usable for communications between a wireless AP and one or more wireless STAs.

FIG. 3 shows an example of a timeline that supports backoff periods according to some aspects of the present disclosure.

FIG. 4 shows an example of graphs that support backoff periods according to some aspects of the present disclosure.

FIG. 5 shows an example of a process flow that supports backoff periods according to some aspects of the present disclosure.

FIG. 6 shows a block diagram of an example wireless communication device that supports backoff periods according to some aspects of the present disclosure.

FIGS. 7 through 10 show flowcharts illustrating example processes that support backoff periods according to some aspects of the present disclosure.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 (for example, “Wi-Fi”) standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

In some wireless communication systems, multiple wireless devices (for example, stations (STAs), access points (APs)) may share a wireless channel (for example, a 5 gigahertz (GHz) band) to communicate signals. To manage shared access to the wireless channel, some wireless devices employ a contention window (CW) with backoff. A contention window may be a range within which a backoff counter may be selected. A wireless device may monitor the wireless channel for activity (for example, transmissions from other wireless devices). For instance, the wireless device may utilize the backoff counter to count a quantity of idle time slots. If the backoff counter satisfies a threshold, the wireless device may attempt to transmit on the wireless channel. When multiple wireless devices attempt to communicate in overlapping time periods, a collision may occur, which may degrade or prevent communications. Some wireless communication systems may utilize contention approaches to share the transmission medium (for example, channel) and manage collisions. When a collision occurs (for example, when multiple wireless devices transmit concurrently), a wireless device may adjust the CW, select another backoff counter, or a combination thereof to attempt to access the wireless channel at a later time.

In some implementations, an Enhanced Distributed Channel Access (EDCA) mechanism is a wireless channel access mechanism that may be utilized in Wi-Fi. In EDCA, channel access may be distributed and each wireless device may determine channel access based on a random backoff time. EDCA may be an example of a listen-before-talk (LBT) protocol, where a wireless device listens to the medium (for a random time, for example) before accessing the medium.

In some implementations, other wireless protocols also may be deployed in the wireless channel. For example, channel access mechanisms may be introduced as defined in European Telecommunications Standards Institute (ETSI) Broadband Access Network (BRAN) for Load Based Equipment (LBT for LBE). For example, Wi-Fi devices (using EDCA) and load-based devices (using LBT for LBE) may be deployed in the 5 GHz band.

In exponential backoff, some wireless devices may start contention operations utilizing a contention window (CW) equal to a minimum value CWmin. For example, EDCA devices may begin operation with a CW equal to a minimum value CWmin. The CW may approximately double after each collision until reaching a maximum value CWmax. A backoff may be selected randomly between 0 and CW, and counted down for each empty slot that occurs in an Arbitration Interframe Space (AIFS) after a transmission. In some implementations, the AIFS is equal to a Short Interframe Space (SIFS) plus 3 slots for STAs, or SIFS plus 2 slots for APs. In some implementations, slots may each be 8 microseconds (μs) in duration, and SIFS may be 16 μs in duration.

Some wireless devices may use a fixed contention window, which may depend on the maximum duration of the transmission. For example, LBT for LBE devices may use a fixed contention window. Each time the medium becomes idle, a random backoff may be determined between zero and the contention window, and a transmission may occur when the backoff is counted down to zero without interruption due to a medium busy condition. In some implementations, the slot time for LBT for LBE is 20 μs.

Because some (for example, EDCA) wireless devices respond to collisions by increasing the backoff duration, while other (for example, LBT for LBE) wireless devices maintain the same channel access priority regardless of collisions, channel access priority may differ significantly between types of devices. For example, when many wireless devices (for example, “nodes”) are present, LBT for LBE wireless devices (or nodes) may have a higher channel access priority relative to EDCA wireless devices (or nodes). Some wireless devices (for example, EDCA wireless devices) may experience significant jitter in channel access time due to exponential backoff.

In some implementations, hidden nodes may occur, where some wireless devices (using exponential backoff) may experience many collisions and accordingly may increase a corresponding contention window, while a competing wireless device that uses deterministic backoff may experience relatively few interruptions of the corresponding backoff, and accordingly may operate at a relatively low backoff. This may result in reduced fairness between deterministic backoff and exponential backoff in at least some conditions.

In some approaches, channel access for wireless devices may be prioritized. For instance, a wireless device may utilize a deterministic backoff period that is based on a backoff value associated with a priority. The backoff value may be utilized to establish a channel access timing (for example, periodicity) associated with the priority. For example, a wireless device may utilize a deterministic backoff period that is based on a quantity of interrupting signals (if any) from a previous backoff period and a backoff value associated a first priority. The backoff value may be based on a default backoff value that may be associated with a default priority. The wireless device may transmit a second signal after the second deterministic backoff period.

By enabling channel access prioritization, the wireless device may access the channel with a priority that allows increased fairness in channel access time between the wireless device and one or more other wireless devices (for example, one or more wireless devices that utilize exponential backoff) that share the channel. Additionally, or alternatively, channel access prioritization may reduce channel access jitter for one or more other wireless devices that share the channel. For example, reducing the priority of a wireless device may reduce transmission frequency, which may allow other wireless devices using exponential backoff a greater probability to access the channel with a reduced quantity of exponential backoff extensions. A reduced quantity of exponential backoff extensions may allow reduce channel access time, reduced channel access jitter, or both.

In some approaches, channel access prioritization may be utilized to prioritize channel access based on one or more factors (for example, traffic type and wireless device type, among other examples). For example, delay sensitive traffic (for example, emergency responder traffic, medical device traffic, vehicle coordination or control traffic, media streaming traffic, among other examples) may be prioritized relative to other traffic types. Additionally, or alternatively, traffic from some wireless device types may be prioritized or deprioritized relative to traffic from other wireless device types. For instance, traffic from some Internet of Things (IoT) devices with relatively higher delay tolerances may be deprioritized relative to traffic from some wireless devices, such as smartphones or laptop computers.

In some implementations, a wireless device may monitor a wireless channel to detect a collision pattern. A collision pattern may be a pattern of colliding transmissions with or without one or more intervening successful transmissions. For example, a collision pattern may occur when successful transmissions are separated by one or more intervening successful transmissions. In response to detection of the collision pattern, the wireless device may utilize a randomized backoff period that is based on an offset value. The offset value may be utilized to extend the randomized backoff period. For example, a wireless device may utilize a randomized backoff period that is based on a random value within a random range and the offset value. The wireless device may transmit a signal after the randomized backoff period.

By enabling randomized backoff period adjustment with an offset value, the wireless device may access the channel with a periodicity that allows increased fairness in channel access time between the wireless device and one or more other wireless devices (for example, one or more wireless devices that utilize exponential backoff) that share the channel. Additionally, or alternatively, randomized backoff using the offset value may reduce channel access jitter for one or more other wireless devices that share the channel. For example, extending the randomized backoff period of a wireless device may reduce transmission frequency, which may allow other wireless devices using exponential backoff a greater probability to access the channel with a reduced quantity of exponential backoff extensions. A reduced quantity of exponential backoff extensions may allow reduce channel access time, reduced channel access jitter, or both.

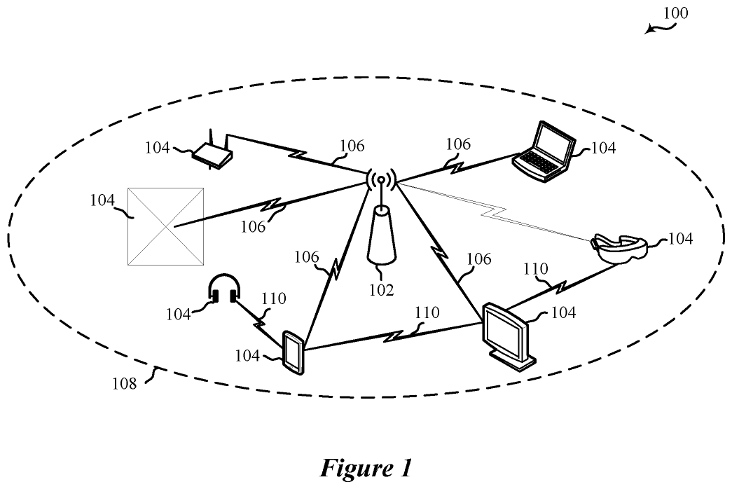

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless AP 102 and any number of wireless STAs 104. In some implementations, the term “wireless device,” as used herein, may refer to a STA 104 or an AP 102. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHZ, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some implementations, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some implementations, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the WLAN wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHZ, and 60 GHz bands. Some implementations of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHZ-7.125 GHZ), FR2 (24.25 GHz-52.6 GHz), FR3 (7.125 GHz-24.25 GHZ), FR4a or FR4-1 (52.6 GHZ-71 GHZ), FR4 (52.6 GHz-114.25 GHZ), and FR5 (114.25 GHZ-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHZ bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHZ, 80 MHz, 160 MHZ, 240 MHZ, 320 MHz, 480 MHz, or 640 MHz by bonding together multiple 20 MHz channels.

In some approaches, channel access for one or more wireless devices (for example, one or more STAs 104, one or more APs 104, or a combination thereof) may be prioritized. For instance, a STA 104 or an AP 104 may utilize a deterministic backoff period that is based on a backoff value associated with a priority. The backoff value may be utilized to establish a channel access timing (for example, periodicity) associated with the priority. For example, some types of data traffic or wireless devices may have associated priorities, and channel access may be managed based on the associated priorities. In some implementations, a wireless device (for example, a first STA 104) may determine a priority for a transmission based on traffic type or wireless device type. For instance, the wireless device may store data that maps categories of traffic or wireless device types to priorities and associated backoff values. In some implementations, a wireless device (for example, a first STA 104) may determine a priority based on a signal to configure a priority. For instance, an AP 102 may send a signal to a first STA 104 indicating (for example, commanding) a priority for the first STA 104 to use or indicating data that maps one or more traffic types or wireless device types to priorities or backoff values.

In some approaches, a wireless device (for example, a first STA 104) with a higher priority may access a transmission medium more frequently than a wireless device (for example, a second STA 104) with a lower priority. For example, priority differentiation may be achieved by reducing a fixed offset in a target CW. The target CW for a default priority p may be given by CW(p)=bcw+2*IPT, where bcw is a default CW and IPT denotes a quantity of interruptions per transmission. A first priority p₁ may be defined by selecting a first CW bcw₁, where bcw₁ is equal to bcw*p/p₁. For example, when p₁ is targeted to have twice the quantity of accesses relative to p, bcw₁ for p₁ may be selected as bcw₁=bcw*1/2=bcw/2. For example, when bcw is 24, bcw₁ would be 12. When p₁ is equal to 3 (implying 3 transmissions for p₁ for each transmission for p), bcw₁ may be selected as bcw*1/3, so bcw₁=bcw/3 (so bcw₁=8 when bcw=24). Selecting a CW may result in priority differentiation with reduced collisions (or without collisions) because the overall cycle time may contain an integer quantity of cycles for each priority.

In some implementations, a default backoff value b may be defined as the default CW divided by 2 (for example, b=bcw/2). The default cycle time (in slots) c for a wireless device with the default priority p may be equal to the associated default backoff b+1, where 1 may account for a transmission of the wireless device with the default priority, plus a quantity of transmissions by a first wireless device with the first priority p₁ that are captured in a first cycle time C₁ at the first priority for p₁/p, where c=b+1+p₁/p. Because b=bcw/2, a first backoff value b₁=bcw₁/2 and so on. Accordingly, because bcw₁=bcw*p/p₁, b₁=b*p/p₁.

The first cycle time C₁ for the first wireless device with the first priority p₁ may be equal to an associated first backoff value b₁+1, where 1 accounts for a transmission of the first wireless device with the first priority p₁, times a quantity of first priority transmissions per cycle p₁/p, plus 1 (where 1 accounts for the first priority p₁). where c₁=(b₁+1)*(p₁/p)+1. Solving for the first priority p₁ by setting the cycle times equal (c=c₁) yields b₁=b*(p₁/p). In some implementations, a backoff period backoff may be determined as a backoff value bₓ (associated with a priority pₓ) plus a quantity of zero or more interrupting signals IPT (from a previous backoff period). For instance, the backoff period may be expressed as backoff=bₓ+IPT. The backoff value bₓ may be a multiple of the default backoff value b or may be a divisor of the default backoff value b. A transmission cycle time C for a set of backoff values b; may be expressed as C=b+sum (b/bₖ) for a set of wireless devices (or nodes) k.

In some implementations, a set of backoff values bᵢ may be such that the cycle time C is an integer. For example, each lower bᵢ may divide all higher bᵢ, where each bᵢ may divide a next higher bᵢ, if there is a next higher bᵢ. In some implementations, bₙ is evenly divisible by any lower backoff value (with a higher index) in bᵢ, or bₙ/bₘ∈ [symbol] , where by is a backoff value in bᵢ, [symbol] is the set of integers, and bₘ is any backoff value in bᵢ that is less than bₙ, if any. For example, bᵢ=24, 12, 6, 3 may be a valid set of backoff values and bᵢ=24, 12, 4, 2 also may be a valid set of backoff values. In some implementations, b=24 may be a lower priority than AC_BE for EDCA, 12 may be approximately the same priority as AC_BE, and backoff values lower than 12 may be higher priorities than AC_BE, but lower priority than AC_VI and AC_VO, because AC_VI and AC_VO may use a lower AIFSN. In some implementations, the priorities for deterministic backoff may be subpriorities for a given default priority (for example, deterministic backoff AC). In some implementations, one or more subpriorities may be utilized for each AC when the AC uses deterministic backoff.

By enabling channel access prioritization, a wireless device may access the channel with a priority that allows increased fairness in channel access time between the wireless device and one or more other wireless devices that share the channel. Additionally, or alternatively, channel access prioritization may reduce channel access jitter for one or more other wireless devices that share the channel.

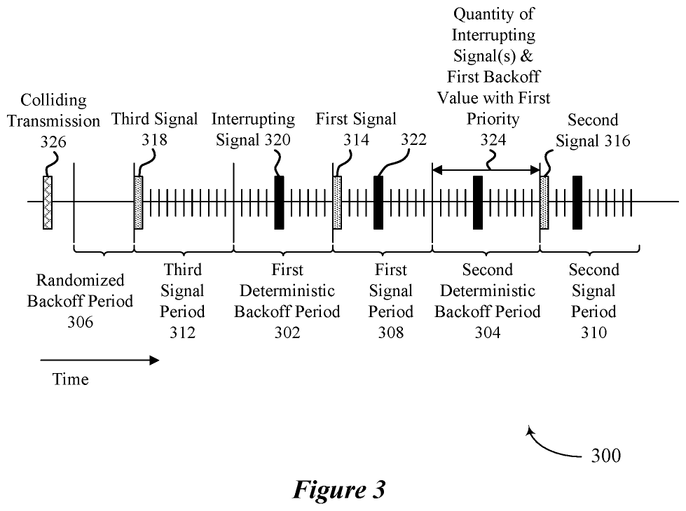

In some implementations, traffic of the same priority may end up at the same overlapping schedule, in which case a threshold of a quantity of repeated colliding transmissions (for example, a retry count equal to 2 or larger) may be utilized to trigger a random backoff to help the system exit the persistent overlapping state. For multiple priorities, a condition to randomize may generalize to the occurrence of 2 or more collisions separated by the same quantity of successes. In some implementations, one or more wireless devices (for example, one or more STAs 104, one or more APs 104, or a combination thereof) may perform channel prioritization or randomized backoff adjustment as described with reference to one or more of FIGS. 3-10.

In some approaches, a random backoff may be increased in a case that a threshold quantity of collisions occurred at a deterministic backoff node. For example, a wireless device (for example, a STA 104 or an AP 102) may monitor a wireless channel to detect a collision pattern. In a case that the collision pattern is detected, the wireless device may utilize a randomized backoff period that is based on an offset value. For instance, the offset value (for example, a fixed block size offset value) may be added to the randomized backoff period. The offset value may be utilized to extend the randomized backoff period. The randomized backoff period may remain relatively small. In some implementations, the offset value may be increased as a function of a quantity of repeated colliding transmissions. The increase may be linear or exponential, or may follow another curve as a function of the quantity of repeated colling transmissions. In some implementations, the offset value may be capped at a maximum value. Interruptions may not be counted during the random backoff period, which potentially may include the offset value (for example, fixed non-random offset value). The wireless device may transmit a signal after the randomized backoff period.

An example of a set of rules (for example, pseudocode) that a wireless device (for example, STA 104 or AP 102) may utilize for determining a backoff period is provided in Listing (1), where comments are denoted in square brackets.

```
when selecting a new backoff
  if retry count < min consecutive retries
    backoff = base backoff + IPT
    [This is an example of deterministic backoff.]
    IPT = 0
  else
    backoff = rand(0, random range) + offset
    where offset = block size × (retry count − min consecutive retries)
```

[This is an example of a randomized backoff with a random range of random range slots. When the quantity of repeated colliding transmissions increases, the backoff may be increased with an offset value in steps of block size slots. In some implementations, the increase may be exponential, may start after the 4th retry, or may be capped to a maximum, among other examples.]

```
    IPT remains unchanged
after a collision
  retry count = retry count + 1
after a successful transmission
  retry count = 0
for each interrupting transmission of a deterministic backoff
  IPT = IPT + 1
  [IPT may not be counted during a random backoff,
  and may be carried over to
  the next deterministic backoff that occurs. An
  example of an interrupting
  transmission is a CCA busy event.]
```

### Listing (1)

In Listing (1), “min consecutive retries” is an example of a threshold of a quantity of repeated colliding transmissions (for example, a minimum quantity of retries before a random backoff occurs, such as 3 slots), “base backoff” is the offset value for a deterministic backoff (for example, 7 slots, 11 slots, 12 slots or another quantity of slots), “random range” is a range in which the backoff is randomized (for example, 6 slots or another quantity of slots), and “block size” is a quantity of slots by which the backoff is increased once the quantity of retries exceeds “min consecutive retries” (for example, 32 slots).

In the example of Listing (1), the randomized backoff period is increased by a block size for each subsequent retry. In some implementations, the offset value may include a random quantity of block sizes. The range in which the random quantity of block sizes is selected may increase with the quantity of repeated colliding transmissions.

In some approaches, one or more backoffs may be random backoffs in an initial random range (for an initial transmission, for example). For instance, one or more random backoffs may be utilized (instead of one or more deterministic backoffs, for example). An example of a set of rules (for example, pseudocode) that a wireless device (for example, STA 104 or AP 102) may utilize for determining a backoff period is provided in Listing (2), where comments are denoted in square brackets.

```
if retry count < min consecutive retries
  backoff = rand(0, initial random range)
  [This is an example of an initial random backoff.]
  IPT = 0
else
  backoff = rand(0, random range) + offset
  where offset = block size × (retry count − min consecutive retries)
```

[This is an example of a randomized backoff with a random range of random range slots. When the quantity of repeated colliding transmissions increases, the backoff may be increased with an offset value in steps of block size slots. In some implementations, the increase may be exponential, may start after the 4th retry, or may be capped to a maximum, among other examples.]
IPT remains unchanged

```
after a collision
  retry count = retry count + 1
after a successful transmission
  retry count = 0
```

### Listing (2)

In Listing (2), “initial random range” denotes a range in which an initial backoff is randomized (for example, 6 slots or another quantity of slots). In some implementations, one or more backoffs may be determined using random backoff approaches without deterministic backoff. In some implementations, once a first successful transmission occurs, one or more backoffs may be determined using a deterministic backoff approach (for example, in accordance with the example of Listing (1) with deterministic backoffs).

In the example of Listing (1), the randomized backoff period is increased by a block size for each subsequent retry. In some implementations, the offset value may include a random quantity of block sizes. The range in which the random quantity of block sizes is selected may increase with the quantity of repeated colliding transmissions.

By enabling randomized backoff period adjustment with an offset value, the wireless device may access the channel with a periodicity that allows increased fairness in channel access time between the wireless device and one or more other wireless devices that share the channel. Additionally, or alternatively, randomized backoff using the offset value may reduce channel access jitter for one or more other wireless devices that share the channel.

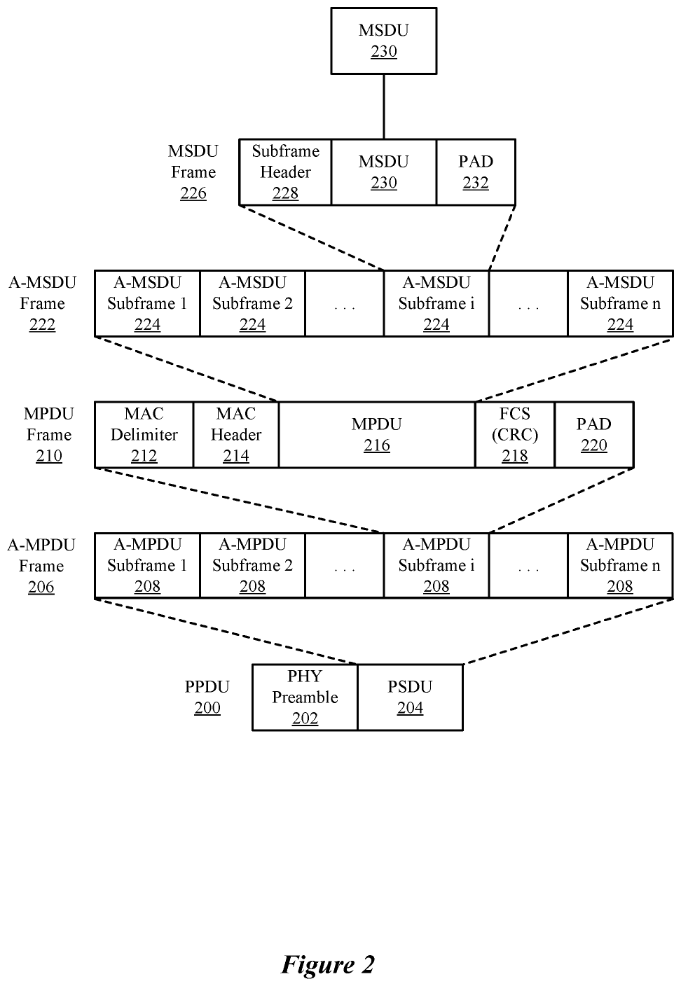

FIG. 2 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 200 includes a PHY preamble 202 and a PSDU 204. Each PSDU 204 may represent (or “carry”) one or more MAC protocol data units (MPDUs) 216. For example, each PSDU 204 may carry an aggregated MPDU (A-MPDU) 206 that includes an aggregation of multiple A-MPDU subframes 208. Each A-MPDU subframe 206 may include an MPDU frame 210 that includes a MAC delimiter 212 and a MAC header 214 prior to the accompanying MPDU 216, which includes the data portion (“payload” or “frame body”) of the MPDU frame 210. Each MPDU frame 210 also may include a frame check sequence (FCS) field 218 for error detection (for example, the FCS field may include a cyclic redundancy check (CRC)) and padding bits 220. The MPDU 216 may carry one or more MAC service data unit (MSDU) frames 226. For example, the MPDU 216 may carry an aggregated MSDU (A-MSDU) 222 including multiple A-MSDU subframes 224. Each A-MSDU subframe 224 contains a corresponding MSDU 230 preceded by a subframe header 228 and in some implementations followed by padding bits 232.

Referring back to the MPDU frame 210, the MAC delimiter 212 may serve as a marker of the start of the associated MPDU 216 and indicate the length of the associated MPDU 216. The MAC header 214 may include multiple fields containing information that defines or indicates characteristics or attributes of data encapsulated within the frame body 216. The MAC header 214 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 214 also includes one or more fields indicating addresses for the data encapsulated within the frame body 216. For example, the MAC header 214 may include a combination of a source address, a transmitter address, a receiver address or a destination address. The MAC header 214 may further include a frame control field containing control information. The frame control field may specify a frame type, for example, a data frame, a control frame, or a management frame.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and then contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some implementations, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (for example, identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is then compared to a threshold to determine (for example, identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

In some implementations, each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (for example, the AP 102 or the STA 104) may contend for access to the wireless medium of WLAN 100 in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). In some implementations, the prioritization described with reference to one or more of FIG. 1. and FIGS. 3-10 may correspond to, or may be different from, the AC priorities described with reference to FIG. 2. Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Retransmission protocols, such as hybrid automatic repeat request (HARQ), also may offer performance gains. A HARQ protocol may support various HARQ signaling between transmitting and receiving wireless communication devices (for example, the AP 102 and the STAs 104 described with reference to FIG. 1) as well as signaling between the PHY and MAC layers to improve the retransmission operations in a WLAN. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some implementations, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a WLAN may improve reliability of data communicated from a transmitting device to a receiving device. The HARQ protocol may support the establishment of a HARQ session between the two devices. Once a HARQ session is established, if a receiving device cannot properly decode (and cannot correct the errors) a first HARQ transmission received from the transmitting device, the receiving device may transmit a HARQ feedback message to the transmitting device (for example, a negative acknowledgement (NACK)) that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some implementations, the receiving device may be enabled to control whether to continue the HARQ process or revert to a non-HARQ retransmission scheme (such as an automatic repeat request (ARQ) protocol). Such switching may reduce feedback overhead and increase the flexibility for retransmissions by allowing devices to dynamically switch between ARQ and HARQ protocols during frame exchanges. Some implementations also may allow multiplexing of communications that employ ARQ with those that employ HARQ.

In some environments, locations, or conditions, a regulatory body may impose a power spectral density (PSD) limit for one or more communication channels or for an entire band (for example, the 6 GHz band). A PSD is a measure of transmit power as a function of a unit bandwidth (such as per 1 MHZ). The total transmit power of a transmission is consequently the product of the PSD and the total bandwidth by which the transmission is sent. Unlike the 2.4 GHZ and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz. respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some implementations in which transmissions are subject to a PSD limit, the AP 102 or the STAs 104 of the wireless communication network WLAN 100 may transmit over a greater transmission bandwidth to allow for an increase in the total transmit power, which may increase an SNR and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (for example, duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number of tones or subcarriers that are allocated to a given STA 104 for transmission of a PPDU. As used herein, the term “regular RU” (or rRU) refers to any RU or MRU tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHZ, 80 MHz or more. The use of dRUs may be limited to uplink communications because benefits to addressing PSD limits may only be present for uplink communications.

FIG. 3 shows an example of a timeline 300 that supports backoff periods according to some aspects of the present disclosure. The timeline 300 illustrates examples of signals and backoff periods that may be utilized in accordance with one or more of the prioritization approaches described herein. One or more of the operations described with reference to FIG. 3 may be performed by one or more wireless devices described with reference to FIG. 1 (for example, by one or more STAs 104, by one or more APs 102, or a combination thereof).

In the example of FIG. 3, a first wireless device may monitor a wireless channel during a first deterministic backoff period 302 to identify a first quantity of zero or more interrupting signals. For instance, the first wireless device may perform energy detection or may measure a signal strength received during the first deterministic backoff period 302 (for example, may perform a CCA as described with reference to FIG. 2). In the example of FIG. 3, the first wireless device detects one interrupting signal 320 occurring during the first deterministic backoff period 302.

The first wireless device may transmit a first signal 314 after the first deterministic backoff period 302. For instance, a STA 104 may transmit the first signal 314 to the AP 102. In some implementations, the first signal 314 may be transmitted during a first signal period 308. The first signal period 308 that includes the first signal 314 may include one or more transmissions by the first wireless device (for example, the first signal 314) and zero or more transmissions by zero or more responding wireless devices (for example, another interrupting signal 322). In some implementations, transmissions (for example, a pair of transmissions) may be separated by a SIFS or a point coordination function (PCF) interframe space (PIFS). For instance, the first signal 314 and the interrupting signal 322 may be separated by a SIFS or PIFS.

The first signal 314 (for example, the first signal period 308) may be followed by a second deterministic backoff period 304. The second deterministic backoff period 304 may be based on the first quantity of the zero or more interrupting signals and a first backoff value associated with a first priority 324. For example, the first wireless device may determine a duration in time of the second deterministic backoff period 304 as a sum of the first quantity and a first backoff value. In one example, the first backoff value b₁=12, the first backoff value is associated with a first priority p₁=2, and the first quantity IPT=1. Accordingly, the duration in time of the second deterministic backoff period 304 (for example, backoff) may be determined as 12+1=13 slots, which may be calculated in accordance with the equation backoff=b₁+IPT as described herein.

In some implementations, the first backoff value is based on a default backoff value, where the default backoff value is associated with a default priority. For instance, the default backoff value may be b=24 and may have a default priority of p=1. The first backoff value may be associated with a first priority p₁=2. Accordingly, the first backoff value b₁ may be 24*(1/2)=12, which may be calculated in accordance with the equation b₁=b*p/p₁ as described herein. In some implementations, the first backoff value may be a multiple of the default backoff value or a divisor of the default backoff value. For instance, the first backoff value may be an integer multiple of the default backoff value or may be a divisor of the default backoff value (where the first backoff value is an integer that is a factor of the default backoff value). In an example, the first backoff value is 12, which is a divisor of the default backoff value of 24.

By enabling channel access prioritization, a wireless device may access the channel with a priority that allows increased fairness in channel access time between the wireless device and one or more other wireless devices that share the channel. Additionally, or alternatively, channel access prioritization may reduce channel access jitter for one or more other wireless devices that share the channel.

In some implementations, the first backoff value and the default backoff value are included in a set of backoff values and each backoff value is a divisor of a greatest backoff value included in the set of backoff values. In an example, a set of backoff values bᵢ=24, 12, 6, 3 incudes a default backoff value of 24 and a first backoff value of 12. As described herein, bₙ/bₘ∈ [symbol] . In this example, each lower backoff value (for example, b₁=12, b₂=6, and b₃=3) is a divisor of the greatest backoff value (for example, b₀=24) in the set of backoff values.

In some implementations, the first backoff value and the default backoff value are included in a set of backoff values and each backoff value is a multiple of a smallest backoff value included in the set of backoff values. In an example, a set of backoff values bᵢ=24, 12, 6, 3 incudes a default backoff value of 24 and a first backoff value of 12. In this example, the each backoff value (for example, 24, 12, 6, and 3) is a multiple of the smallest backoff value (for example, 3) in the set of backoff values.

In some implementations, the first backoff value and the default backoff value are included in a set of backoff values, and each backoff value except a smallest backoff value is a multiple of a next smaller backoff value included in the set of backoff values. In an example, a set of backoff values bᵢ=24, 12, 6, 3 incudes a default backoff value of 24 and a first backoff value of 12. In this example, the each backoff value except a smallest backoff value (for example, 24, 12, 6) is a multiple of a next smaller backoff value in the set of backoff values. For instance, 24 is a multiple of 12, 12 is a multiple of 6, and 6 is a multiple of 3. While some values are given for purposes of illustration, other values may be utilized in some implementations.

The first wireless device may transmit a second signal 316 after the second deterministic backoff period 304. For example, after the second deterministic backoff period 304 ends, the first wireless device may transmit the second signal 316 (for example, a STA 104 may transmit the second signal to the AP 102). The second signal 316 may be transmitted in a second signal period 310.

In some implementations, the first wireless device may transmit a plurality of signals periodically after the second signal 316 in accordance with a ratio between the first priority and the default priority. For instance, the first wireless device may transmit a plurality of signals after the second signal 316 in accordance with a first periodicity that is based on the ratio p₁:p. In an example where the first priority p₁=2 and the default priority p=1, the first wireless device may transmit a plurality of signals periodically with approximately 2 times the periodicity of the default priority.

In some implementations, the zero or more interrupting signals (for example, interrupting signals 320, interrupting signal 322, and so on) are respectively transmitted by one or more second wireless devices (for example, another STA(s) 104) of a set of wireless devices. Each of the one or more second wireless devices may transmit in accordance with one or more respective second backoff values associated with one or more respective priorities. A transmission cycle of the set of wireless devices may be based on the first backoff value and one or more ratios of the first backoff value to the one or more respective second backoff values. For example, the transmission cycle of the set of wireless devices may be expressed as C=b+sum(b/bₖ). In an example where b=24 and bₖ=12, 6, 3, the transmission cycle C=24+(24/12)+(24/6)+(24/3)=38. One or more of the CWs, backoff values, or transmission cycles described herein may be expressed in units of slots, seconds, milliseconds, or microseconds, etc.

In some cases, one or more collisions may occur between a transmission of the first wireless device and a transmission of another wireless device. When one or more collisions occur, the first wireless device may utilize randomized backoff in an attempt to avoid another collision. For example, when a colliding transmission 326 occurs, the first wireless device may determine a randomized backoff period 306 (for example, a random quantity of slots) to wait (for example, count) before sending another signal. If the signal transmission after the randomized backoff period 306 is successful, the first wireless device may utilize deterministic backoff.

In some implementations, the first wireless device may transmit a third signal 318 after a randomized backoff period 306 and before the first deterministic backoff period 302. The third signal 318 may be transmitted in a third signal period 312. The randomized backoff period 306 may be based on detecting a collision pattern including zero or more successful transmissions between colliding transmissions. For example, the first wireless device may detect a colliding transmission 326 when another transmission is detected that overlaps with a transmission by the first wireless device, when an ACK corresponding to first wireless device's transmission is not received by the first wireless device, when no response corresponding to first wireless device's transmission is received by the first wireless device, or when a NACK corresponding to first wireless device's transmission is received by the first wireless device, among other examples. The first wireless device may detect a successful transmission when an ACK corresponding to first wireless device's transmission is received by the first wireless device or when a response corresponding to first wireless device's transmission is received by the first wireless device, among other examples.

A collision pattern may include a pattern of alternating colliding transmissions and successful transmissions. For example, one or more successful transmissions may be detected for each detected colliding transmission. For instance, a colliding transmission may be detected followed by one or more successful transmissions followed by a repeated colliding transmission as described with reference to FIG. 1. For example, the first wireless device may detect the collision pattern in a case that that a threshold quantity of collisions occurred with zero or more intervening successful transmissions as described with reference to FIG. 1 and Listing (1). For instance, if retry count<min consecutive retries (if a quantity of repeated colliding transmissions reaches “min consecutive retries”), the collision pattern may be detected. Detection of a collision pattern may indicate that wireless devices with different priorities are cyclically aligned. In response to the detection of the collision pattern, the wireless device may determine the randomized backoff period 306. For example, the first wireless device may select a backoff period based on a bounded random range as described with reference to Listing (1), where backoff=rand (0, random range)+offset.

In some implementations, first wireless device may transition to a deterministic backoff procedure in response to detection of a successful transmission. For instance, when the first wireless device detects success transmission of the third signal 318, the first wireless device may switch from utilizing a randomized backoff period (for example, randomized backoff period 306) to a deterministic backoff period (for example, first deterministic backoff period 302). For example, in a case of a successful transmission after a randomized backoff period 306, the first wireless device may reset the quantity of colliding transmissions (“retry count=0”) and may utilize a deterministic backoff procedure as described with reference to Listing (1). If another collision is detected, the first wireless device may increment the quantity of colliding transmissions (“retry count=retry count+1”) and perform another random backoff, where the offset value may be adjusted as described with reference to Listing (1). The monitoring for the first quantity of zero or more interrupting signals may be performed in response to a successful transmission of the third signal 318.

In some implementations, the first wireless device may detect a collision pattern based on a threshold of a quantity of repeated colliding transmissions. For example, the first wireless device may count one or more (for example, cyclical) colliding transmissions (with or without one or more intervening successful transmissions). In a case that the count satisfies the threshold, the first wireless device may detect a collision pattern. The first wireless device may transmit a third signal 318 after a randomized backoff period 306 and before the first deterministic backoff period 302 in response to detecting the collision pattern.

In some implementations, the randomized backoff period 306 may be based on a random value within a random range and an offset value. For example, the first wireless device may determine the randomized backoff period 306 based on a sum of the random value determined (or generated) within the random range and the offset value (for example, backoff=rand (0, random range)+offset) as described with reference to FIG. 1 and Listing (1).

In some implementations, the offset value may be determined in accordance with a function that increases with the quantity of repeated colliding transmissions. The function may increase linearly, may increase exponentially, may be limited to a range within a maximum value, or a combination thereof. For instance, the function may include a block size value multiplied by a difference between the quantity of repeated colliding transmissions and a minimum quantity of repeated colliding transmissions to trigger the randomized backoff period 306 (for example, offset=block size×(retry count−min consecutive retries)) as described with reference to FIG. 1 and Listing (1). In some implementations, the block size indicates a quantity of time for increasing the first backoff value.

The block size value may be a random quantity within a range that increases with the quantity of repeated colliding transmissions. For instance, the first wireless device may determine the block size as a random quantity within a range. The range may increase (for example, linearly increase, exponentially increase, increase in accordance with a stepwise function) with the quantity of repeated colliding transmissions (for example, the counted quantity of collisions).

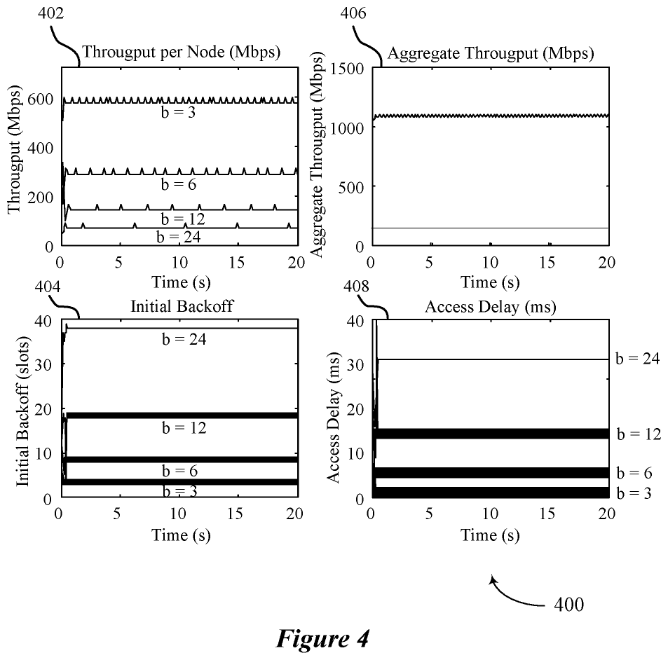

FIG. 4 shows an example of graphs 400 that support backoff periods according to some aspects of the present disclosure. In particular, FIG. 4 illustrates a first graph 402 of throughput for four wireless devices or nodes (in megabits per second (Mbps) over time (in seconds)). A second graph 404 illustrates initial backoff values (in slots) over time (in seconds) for four nodes. A third graph 406 illustrates an aggregated throughput (in Mbps) for the four nodes. A fourth graph 408 illustrates an access delay (in milliseconds) for the four nodes.

As illustrated in the graphs 400, a first node utilized a first backoff value of b=24 with a first priority (for example, a lowest priority), a second node utilized a second backoff value of b=12 with a second priority, a third node utilized a third backoff value of b=6 with a third priority, and a fourth node utilized a fourth backoff value of b=3 with a fourth priority (for example, a highest priority). For bᵢ=24, 12, 6, and 3, and using 3 successes per collision as the trigger to randomize the backoff, the nodes performed as illustrated in the graphs 400.

Specifically, the first graph 402 illustrates more frequent channel accesses for the fourth node with the backoff value of 3 relative to the other nodes with respective backoff values of 6, 12, and 24. As illustrated in the second graph 404 and the fourth graph 408, higher backoff values translated to greater initial backoff times and increased access delays. The graphs 400 illustrate that different deterministic backoff values with respective (and different) priorities may be implemented as described herein. The graphs 400 also illustrate randomized backoffs for the nodes in initial portions of the graphs 400. As illustrated in FIG. 4, the overall schedule is generally collision-free while having different priorities, except for a few initial collisions followed by a few random backoffs based on the trigger.

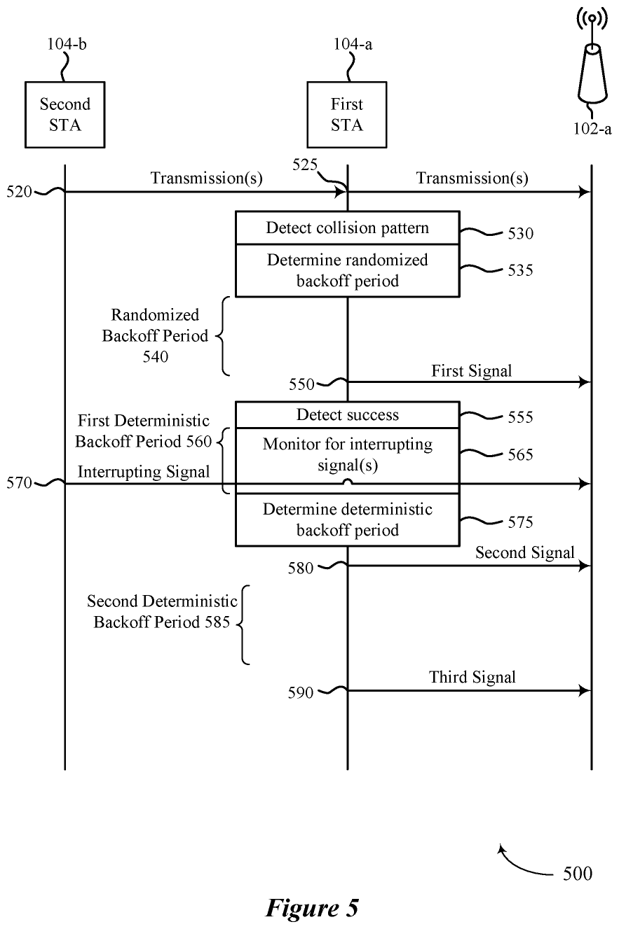

FIG. 5 shows an example of a process flow 500 that supports backoff periods according to some aspects of the present disclosure. The process flow 500 may include a first STA 104-a, which may be an example of STAs 104, as described herein. The process flow 500 also may include an AP 102-a, which may be an example of the AP 102, as described herein. The process flow 500 also may include a second STA 104-b, which may be an example of an second STA 104-b described herein.

In the following description of the process flow 500, the operations between the AP 102-a, the first STA 104-a, and the second STA 104-b may be transmitted in a different order than the example order shown, or the operations performed by the AP 102-a, the first STA 104-a, and the second STA 104-b may be performed in different orders or at different times. Some operations also may be omitted from the process flow 500, and other operations may be added to the process flow 500. Further, although some operations or signaling may be shown to occur at different times for discussion purposes, these operations may actually occur at the same time or in overlapping time frames.

At 520, the second STA 104-b may send one or more transmissions to the AP 102-a. At 525, the first STA 104-a may send one or more transmissions to the AP 102 in one or more overlapping time periods. The first STA 104-a may monitor the wireless channel to detect a collision pattern. For instance, the first STA 104-a may monitor the wireless channel to detect one or more colliding transmissions that may be separated by zero or more successful transmissions.

At 530, the first STA 104-a may detect a collision pattern. For example, the first STA 104-a may detect the collision pattern based on a threshold of a quantity of repeated colliding transmissions. When the threshold is satisfied, the collision pattern may be detected. As used herein, “satisfying a threshold” may, depending on the context, refer to a value being greater than the threshold, greater than or equal to the threshold, less than the threshold, less than or equal to the threshold, equal to the threshold, not equal to the threshold, or the like. For instance, the threshold of the quantity of repeated colliding transmissions may be 2, 3, or 4, etc. In an example, the first STA 104-a may detect a first colliding transmission and a second colliding transmission separated by two successful transmissions as described with reference to FIG. 1. With a threshold of 2, the first STA 104-a may detect the collision pattern when the second colliding transmission is detected. The collision pattern may indicate that the first STA 104-a and the second STA 104-b have entered a persistent overlapping state. In response to the detection of the collision pattern, the first STA 104-a may trigger a random backoff to exit the persistent overlapping state.

At 535, in some implementations, the first STA 104-a may determine a randomized backoff period 540. For example, the first STA 104-a may determine the randomized backoff period 540 as described with reference to FIG. 1 or FIG. 3. For instance, the first STA 104-a may determine the randomized backoff period 540 based on a random value within a random range and an offset value as described with reference to FIG. 1.

The random range may be a range within which the random value may be determined, selected, or generated. For instance, if the random range is 12, the first STA 104-a may randomly select a random value between 1 and 12 (using a random number generation procedure, for example). The offset value may provide flexibility in scenarios where a set of wireless devices that use deterministic and exponential backoff, which may result in more equitable access times or throughput between wireless devices.

In some implementations, the offset value may be determined in accordance with a function that increases with the quantity of repeated colliding transmissions. For instance, the function may include a block size value (“block size” that indicates a quantity of time for increasing the first backoff value) multiplied by a difference between the quantity of repeated colliding transmissions (“retry count”) and a minimum quantity of collisions (“min consecutive retries”) to trigger the randomized backoff period in accordance with the equation backoff=rand (0, random range)+offset, where offset=block size×(retry count-min consecutive retries), as described with reference to FIG. 1 and Listing (1). The function may increase linearly, may increase exponentially, may be limited to a range within a maximum value, or may be a combination thereof. In some implementations, the block size value may be a random quantity within a range that increases with the quantity of collisions. A linear increase may provide slower growth to the offset, which may keep access time lower at a cost of a greater probability of a repeated collision. The linear increase function may be suited to applications or traffic that are sensitive to jitter but that can tolerate more collisions. An exponential increase may provide a lower probability of repeated collision at the cost of higher jitter. The exponential increase function may be suited to applications or traffic that can tolerate higher jitter.

By enabling randomized backoff period adjustment with an offset value, the wireless device may access the channel with a periodicity that allows increased fairness in channel access time between the wireless device and one or more other wireless devices that share the channel. Additionally, or alternatively, randomized backoff using the offset value may reduce channel access jitter for one or more other wireless devices that share the channel.

At 550, the first STA 104-a may transmit a first signal after the randomized backoff period 540 in response to detecting the collision pattern. As described herein, the randomized backoff period 540 may be based on a random value within a random range and an offset value.

At 555, the first STA 104-a may detect a successful transmission of the first signal. For example, the STA 104-a may receive an ACK or a response from the AP 102-a to detect the successful transmission of the first signal as described with reference to FIG. 1. In response to the detection of the successful transmission, the first STA 104-a may utilize a first deterministic backoff period 540.

At 565, the first STA 104-a may monitor the wireless channel during the first deterministic backoff period 560 after the first signal to identify a first quantity of zero or more interrupting signals. For example, the first STA 104-a may monitor the wireless channel as described with reference to one or more of FIG. 1, FIG. 2, and FIG. 3.

At 570, the second STA 104-b may transmit an interrupting signal. The first STA 104-a may detect the interrupting signal. For instance, the first STA 104-a may count the interrupting signal in the first quantity of interrupting signal(s) (for example, IPT) as described with reference to one or more of FIGS. 1 and 3.

At 575, the first STA 104-a may determine a deterministic backoff period. For example, the first STA 104-a may add the first quantity of zero or more interrupting signals to a first backoff value b₁ to determine the deterministic backoff period in accordance with the equation backoff=b₁+IPT as described with reference to FIG. 1. In some implementations, the first backoff value b₁ (for example, a quantity of slots or an amount of time) may be associated with a first priority p₁ or may be a default backoff value (b₁=b) for the first STA 104-a. In some implementations, the second STA 104-b may have the same first priority p₁ or a different second priority p₂ relative to the first STA 104-a. For example, the first STA 104-a and the second STA 104-b may utilize backoff values in a set of backoff values bᵢ=24, 12, 6, 3, where each backoff value is associated with a priority. For instance, the first STA 104-a may utilize a backoff value of 12 and the second STA 104-b may utilize a backoff value of 24, where the first STA 104-a may transmit at approximately half the periodicity (or twice the frequency) of the second STA 104-b as described with reference to FIG. 1.

At 580, the first STA 104-a may transmit a second signal after the first deterministic backoff period 560. For example, the first STA 104-a may transmit the second signal to the AP 102-a after counting a quantity of idle slots in the first deterministic backoff period 560 equal to the first backoff value. The second signal may be followed by a second deterministic backoff period 585 that is based at least in part on the first quantity of the zero or more interrupting signals and the first backoff value.

At 590, the first STA 104-a may transmit a third signal after the second deterministic backoff period 585. For example, the first STA 104-a may transmit a third signal to the AP 102-a.

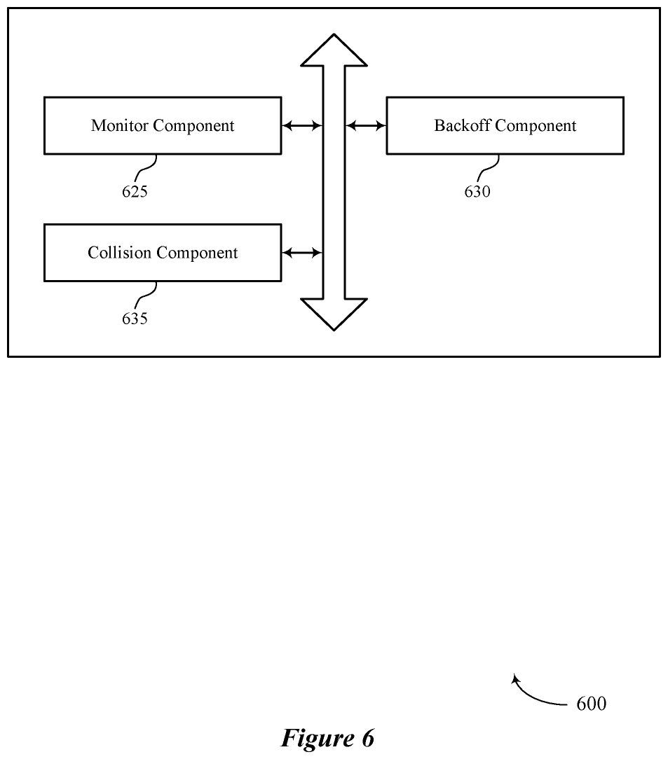

FIG. 6 shows a block diagram of an example wireless communication device 600 that supports backoff periods. In various examples, the wireless communication device 600 can be a chip, SoC, chipset, package or device that may include: one or more modems (such as, a Wi-Fi (IEEE 802.11) modem or a cellular modem such as 3GPP 4G LTE or 5G compliant modem); one or more processors, processing blocks or processing elements (collectively “at least one processor”); one or more radios (collectively “at least one radio”); and one or more memories or memory blocks (collectively “at least one memory”). In some implementations, the at least one processor may include multiple processors, and the at least one memory may include multiple memories. One or more of the multiple processors may be coupled with one or more of the multiple memories which may, individually or collectively, be configured to perform various functions described herein (as part of a processing system).

In some implementations, the wireless communication device 600 can be a device for use in a STA, such as STA 104 described with reference to FIG. 1. In some other examples, the wireless communication device 600 can be a STA that includes such a chip, SoC, chipset, package or device as well as multiple antennas. The wireless communication device 600 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some implementations, the wireless communication device 600 also includes or can be coupled with at least one application processor which may be further coupled with at least one memory. In some implementations, the wireless communication device 600 further includes a user interface (UI) (such as a touchscreen or keypad) and a display, which may be integrated with the UI to form a touchscreen display. In some implementations, the wireless communication device 600 may further include one or more sensors such as, for example, one or more inertial sensors, accelerometers, temperature sensors, pressure sensors, or altitude sensors.

The wireless communication device 600 includes a monitor component 625. a backoff component 630, and a collision component 635. Portions of one or more of the monitor component 625, the backoff component 630, and the collision component 635 may be implemented at least in part in hardware or firmware. For example, one or more of the monitor component 625, the backoff component 630, and the collision component 635 may be implemented at least in part by at least one modem. In some implementations, at least some of the monitor component 625, the backoff component 630, and the collision component 635 are implemented at least in part by at least one processor and as software stored in at least one memory. For example, portions of one or more of the monitor component 625, the backoff component 630, and the collision component 635 can be implemented as non-transitory instructions (or “code”) executable by the at least one processor to perform the functions or operations of the respective module.

In some implementations, the at least one processor may be a component of a processing system. A processing system may generally refer to a system or series of machines or components that receives inputs and processes the inputs to produce a set of outputs (which may be passed to other systems or components of, for example, the device 600). For example, a processing system of the device 600 may refer to a system including the various other components or subcomponents of the device 600, such as the at least one processor, or at least one transceiver, or at least one communications manager, or other components or combinations of components of the device 600. The processing system of the device 600 may interface with other components of the device 600, and may process information received from other components (such as inputs or signals) or output information to other components. For example, a chip or modem of the device 600 may include a processing system, a first interface to output information and a second interface to obtain information. In some implementations, the first interface may refer to an interface between the processing system of the chip or modem and a transmitter, such that the device 600 may transmit information output from the chip or modem. In some implementations, the second interface may refer to an interface between the processing system of the chip or modem and a receiver, such that the device 600 may obtain information or signal inputs, and the information may be passed to the processing system. A person having ordinary skill in the art will readily recognize that the first interface also may obtain information or signal inputs, and the second interface also may output information or signal outputs.

The monitor component 625 is capable of, configured to, or operable to support a means for monitoring a wireless channel during a first deterministic backoff period to identify a first quantity of zero or more interrupting signals. The backoff component 630 is capable of, configured to, or operable to support a means for transmitting, after the first deterministic backoff period, a first signal, the first signal followed by a second deterministic backoff period that is based on the first quantity of the zero or more interrupting signals and a first backoff value associated with a first priority, where the first backoff value is based on a default backoff value, the default backoff value being associated with a default priority. In some implementations, the backoff component 630 is capable of, configured to, or operable to support a means for transmitting a second signal after the second deterministic backoff period.

In some implementations, a first signal period that includes the first signal includes one or more transmissions by the first wireless device and zero or more transmissions by zero or more responding wireless devices. In some implementations, a pair of transmissions is separated by a short interframe space (SIFS) or a point coordination function (PCF) interframe space (PIFS).

In some implementations, the backoff component 630 is capable of, configured to, or operable to support a means for transmitting a third signal after a randomized backoff period and before the first deterministic backoff period, the randomized backoff period being based on a collision pattern including one or more successful transmissions between colliding transmissions being detected, and the wireless channel being monitored in response to a successful transmission of the third signal.

In some implementations, the first backoff value is a multiple of the default backoff value or a divisor of the default backoff value.

In some implementations, the backoff component 630 is capable of, configured to, or operable to support a means for transmitting a set of multiple signals periodically after the second signal in accordance with a ratio between the first priority and the default priority.

In some implementations, the zero or more interrupting signals are respectively transmitted by one or more second wireless devices of a set of wireless devices. In some implementations, each of the one or more second wireless devices transmits in accordance with one or more respective second backoff values associated with one or more respective priorities. In some implementations, a transmission cycle of the set of wireless devices is based on the first backoff value and one or more ratios of the first backoff value to the one or more respective second backoff values.

In some implementations, the first backoff value and the default backoff value are included in a set of backoff values. In some implementations, each backoff value is a divisor of a greatest backoff value included in the set of backoff values.

In some implementations, the first backoff value and the default backoff value are included in a set of backoff values. In some implementations, each backoff value is a multiple of a smallest backoff value included in the set of backoff values.

In some implementations, the first backoff value and the default backoff value are included in a set of backoff values. In some implementations, each backoff value except a smallest backoff value is a multiple of a next smaller backoff value included in the set of backoff values.

In some implementations, the collision component 635 is capable of, configured to, or operable to support a means for detecting a collision pattern based on a threshold of a quantity of repeated colliding transmissions. In some implementations, the backoff component 630 is capable of, configured to, or operable to support a means for transmitting a third signal after a randomized backoff period and before the first deterministic backoff period in response to detecting the collision pattern.

In some implementations, the randomized backoff period is based on a random value within a random range and an offset value.

In some implementations, the offset value is determined in accordance with a function that increases with the quantity of repeated colliding transmissions.

In some implementations, the function includes a block size value, indicating a quantity of time for increasing the first backoff value, multiplied by a difference between the quantity of repeated colliding transmissions and a minimum quantity of repeated colliding transmissions to trigger the randomized backoff period.

In some implementations, the block size value is a random quantity within a range that increases with the quantity of repeated colliding transmissions.

In some implementations, the function increases linearly, increases exponentially, is limited to a range within a maximum value, or a combination thereof.

The collision component 635 is capable of, configured to, or operable to support a means for monitoring a wireless channel to detect a collision pattern. In some implementations, the backoff component 630 is capable of, configured to, or operable to support a means for transmitting a first signal after a randomized backoff period in response to detecting the collision pattern, the randomized backoff period being based on a random value within a random range and an offset value. In some implementations, the monitor component 625 is capable of, configured to, or operable to support a means for monitoring the wireless channel during a first deterministic backoff period after the first signal to identify a first quantity of zero or more interrupting signals. In some implementations, the backoff component 630 is capable of, configured to, or operable to support a means for transmitting, after the first deterministic backoff period, a second signal, the second signal followed by a second deterministic backoff period that is based on the first quantity of the zero or more interrupting signals and a first backoff value. In some implementations, the backoff component 630 is capable of, configured to, or operable to support a means for transmitting a third signal after the second deterministic backoff period.

In some implementations, the collision component 635 is capable of, configured to, or operable to support a means for detecting the collision pattern based on a threshold of a quantity of repeated colliding transmissions.

In some implementations, the offset value is determined in accordance with a function that increases with the quantity of repeated colliding transmissions.

In some implementations, the function includes a block size value, indicating a quantity of time for increasing the first backoff value, multiplied by a difference between the quantity of repeated colliding transmissions and a minimum quantity of collisions to trigger the randomized backoff period.

In some implementations, the block size value is a random quantity within a range that increases with the quantity of collisions.

In some implementations, the function increases linearly, increases exponentially, is limited to a range within a maximum value, or a combination thereof.

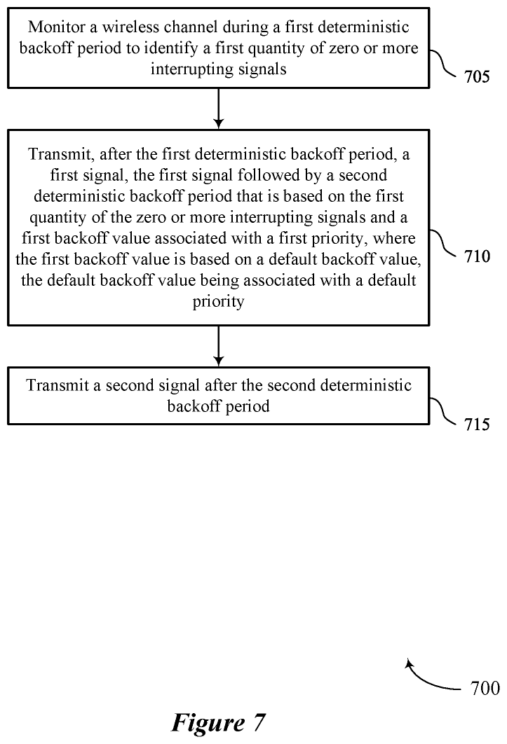

FIG. 7 shows a flowchart illustrating an example process 700 performable at a wireless STA that supports backoff periods according to some aspects of the present disclosure. The operations of the process 700 may be an example of a method implemented by a wireless STA or its components as described herein. For example, the process 700 may be performed by a wireless communication device, such as the wireless communication device 600 described with reference to FIG. 6, operating as or within a wireless STA. In some implementations, the process 700 may be performed by a wireless STA, such as one of the STAs 104 described with reference to FIG. 1.

In some implementations, in block 705, the wireless STA may monitor a wireless channel during a first deterministic backoff period to identify a first quantity of zero or more interrupting signals. The operations of block 705 may be performed in accordance with examples as disclosed herein. In some implementations, aspects of the operations of block 705 may be performed by a monitor component 625 as described with reference to FIG. 6.

In some implementations, in block 710, the wireless STA may transmit, after the first deterministic backoff period, a first signal, the first signal followed by a second deterministic backoff period that is based on the first quantity of the zero or more interrupting signals and a first backoff value associated with a first priority, where the first backoff value is based on a default backoff value, the default backoff value being associated with a default priority. The operations of block 710 may be performed in accordance with examples as disclosed herein. In some implementations, aspects of the operations of block 710 may be performed by a backoff component 630 as described with reference to FIG. 6.

In some implementations, in block 715, the wireless STA may transmit a second signal after the second deterministic backoff period. The operations of block 715 may be performed in accordance with examples as disclosed herein. In some implementations, aspects of the operations of block 715 may be performed by a backoff component 630 as described with reference to FIG. 6.

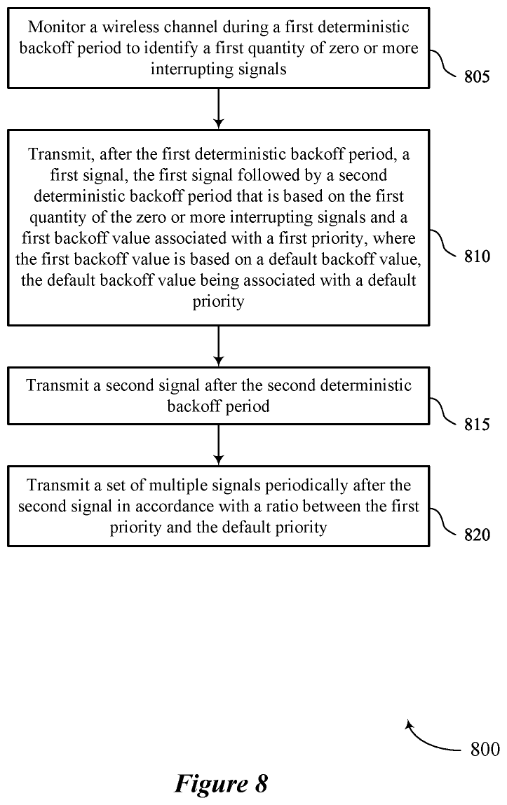

FIG. 8 shows a flowchart illustrating an example process 800 performable at a wireless STA that supports backoff periods according to some aspects of the present disclosure. The operations of the process 800 may be an example of a method implemented by a wireless STA or its components as described herein. For example, the process 800 may be performed by a wireless communication device, such as the wireless communication device 600 described with reference to FIG. 6, operating as or within a wireless STA. In some implementations, the process 800 may be performed by a wireless STA, such as one of the STAs 104 described with reference to FIG. 1.

In some implementations, in block 805, the wireless STA may monitor a wireless channel during a first deterministic backoff period to identify a first quantity of zero or more interrupting signals. The operations of block 805 may be performed in accordance with examples as disclosed herein. In some implementations, aspects of the operations of block 805 may be performed by a monitor component 625 as described with reference to FIG. 6.

In some implementations, in block 810, the wireless STA may transmit, after the first deterministic backoff period, a first signal, the first signal followed by a second deterministic backoff period that is based on the first quantity of the zero or more interrupting signals and a first backoff value associated with a first priority, where the first backoff value is based on a default backoff value, the default backoff value being associated with a default priority. The operations of block 810 may be performed in accordance with examples as disclosed herein. In some implementations, aspects of the operations of block 810 may be performed by a backoff component 630 as described with reference to FIG. 6.

In some implementations, in block 815, the wireless STA may transmit a second signal after the second deterministic backoff period. The operations of block 815 may be performed in accordance with examples as disclosed herein. In some implementations, aspects of the operations of block 815 may be performed by a backoff component 630 as described with reference to FIG. 6.

In some implementations, in block 820, the wireless STA may transmit a set of multiple signals periodically after the second signal in accordance with a ratio between the first priority and the default priority. The operations of block 820 may be performed in accordance with examples as disclosed herein. In some implementations, aspects of the operations of block 820 may be performed by a backoff component 630 as described with reference to FIG. 6.

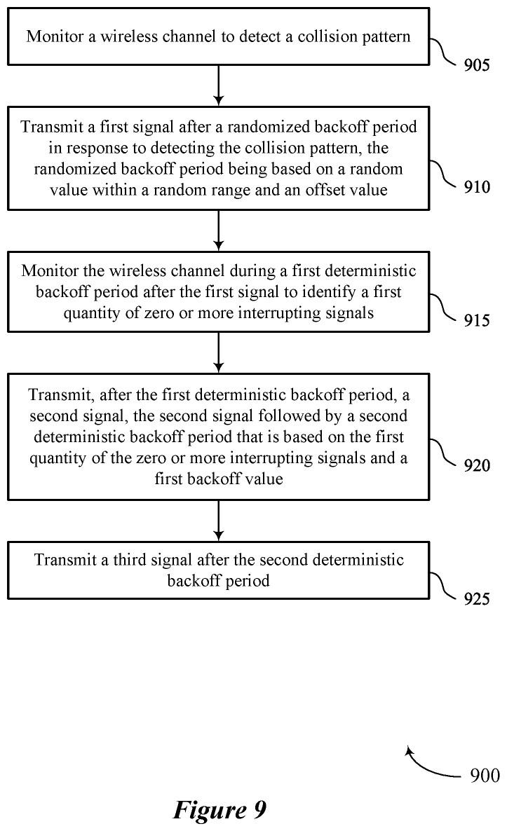

FIG. 9 shows a flowchart illustrating an example process 900 performable at a wireless STA that supports backoff periods according to some aspects of the present disclosure. The operations of the process 900 may be an example of a method implemented by a wireless STA or its components as described herein. For example, the process 900 may be performed by a wireless communication device, such as the wireless communication device 600 described with reference to FIG. 6, operating as or within a wireless STA. In some implementations, the process 900 may be performed by a wireless STA, such as one of the STAs 104 described with reference to FIG. 1.

In some implementations, in block 905, the wireless STA may monitor a wireless channel to detect a collision pattern. The operations of block 905 may be performed in accordance with examples as disclosed herein. In some implementations, aspects of the operations of block 905 may be performed by a collision component 635 as described with reference to FIG. 6.

In some implementations, in block 910, the wireless STA may transmit a first signal after a randomized backoff period in response to detecting the collision pattern, the randomized backoff period being based on a random value within a random range and an offset value. The operations of block 910 may be performed in accordance with examples as disclosed herein. In some implementations, aspects of the operations of block 910 may be performed by a backoff component 630 as described with reference to FIG. 6.

In some implementations, in block 915, the wireless STA may monitor the wireless channel during a first deterministic backoff period after the first signal to identify a first quantity of zero or more interrupting signals. The operations of block 915 may be performed in accordance with examples as disclosed herein. In some implementations, aspects of the operations of block 915 may be performed by a monitor component 625 as described with reference to FIG. 6.

In some implementations, in block 920, the wireless STA may transmit, after the first deterministic backoff period, a second signal, the second signal followed by a second deterministic backoff period that is based on the first quantity of the zero or more interrupting signals and a first backoff value. The operations of block 920 may be performed in accordance with examples as disclosed herein. In some implementations, aspects of the operations of block 920 may be performed by a backoff component 630 as described with reference to FIG. 6.

In some implementations, in block 925, the wireless STA may transmit a third signal after the second deterministic backoff period. The operations of block 925 may be performed in accordance with examples as disclosed herein. In some implementations, aspects of the operations of block 925 may be performed by a backoff component 630 as described with reference to FIG. 6.

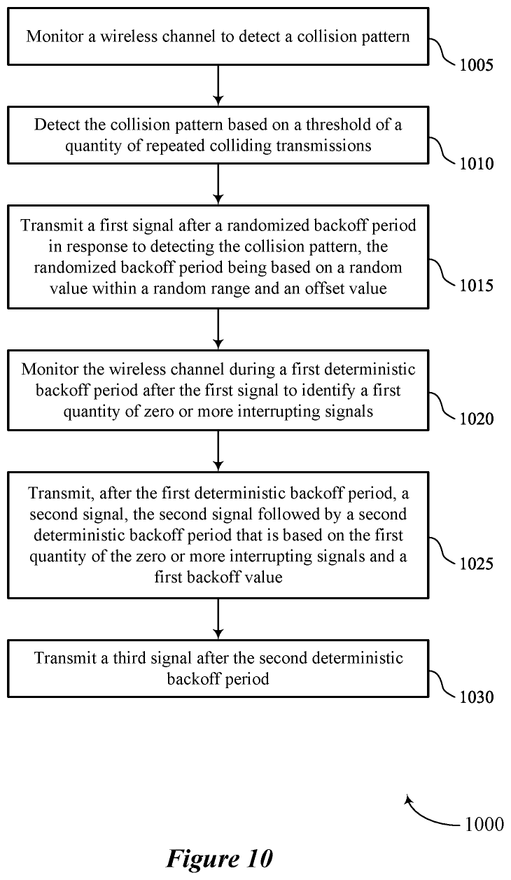

FIG. 10 shows a flowchart illustrating an example process 1000 performable at a wireless STA that supports backoff periods according to some aspects of the present disclosure. The operations of the process 1000 may be an example of a method implemented by a wireless STA or its components as described herein. For example, the process 1000 may be performed by a wireless communication device, such as the wireless communication device 600 described with reference to FIG. 6, operating as or within a wireless STA. In some implementations, the process 1000 may be performed by a wireless STA, such as one of the STAs 104 described with reference to FIG. 1.

In some implementations, in block 1005, the wireless STA may monitor a wireless channel to detect a collision pattern. The operations of block 1005 may be performed in accordance with examples as disclosed herein. In some implementations, aspects of the operations of block 1005 may be performed by a collision component 635 as described with reference to FIG. 6.

In some implementations, in block 1010, the wireless STA may detect the collision pattern based on a threshold of a quantity of repeated colliding transmissions. The operations of block 1010 may be performed in accordance with examples as disclosed herein. In some implementations, aspects of the operations of block 1010 may be performed by a collision component 635 as described with reference to FIG. 6.

In some implementations, in block 1015, the wireless STA may transmit a first signal after a randomized backoff period in response to detecting the collision pattern, the randomized backoff period being based on a random value within a random range and an offset value. The operations of block 1015 may be performed in accordance with examples as disclosed herein. In some implementations, aspects of the operations of block 1015 may be performed by a backoff component 630 as described with reference to FIG. 6.

In some implementations, in block 1020, the wireless STA may monitor the wireless channel during a first deterministic backoff period after the first signal to identify a first quantity of zero or more interrupting signals. The operations of block 1020 may be performed in accordance with examples as disclosed herein. In some implementations, aspects of the operations of block 1020 may be performed by a monitor component 625 as described with reference to FIG. 6.

In some implementations, in block 1025, the wireless STA may transmit, after the first deterministic backoff period, a second signal, the second signal followed by a second deterministic backoff period that is based on the first quantity of the zero or more interrupting signals and a first backoff value. The operations of block 1025 may be performed in accordance with examples as disclosed herein. In some implementations, aspects of the operations of block 1025 may be performed by a backoff component 630 as described with reference to FIG. 6.

In some implementations, in block 1030, the wireless STA may transmit a third signal after the second deterministic backoff period. The operations of block 1030 may be performed in accordance with examples as disclosed herein. In some implementations, aspects of the operations of block 1030 may be performed by a backoff component 630 as described with reference to FIG. 6.

Implementation examples are described in the following numbered clauses:

Aspect 1: A method for wireless communications by a first wireless device, comprising: monitoring a wireless channel during a first deterministic backoff period to identify a first quantity of zero or more interrupting signals; transmitting, after the first deterministic backoff period, a first signal, the first signal followed by a second deterministic backoff period that is based at least in part on the first quantity of the zero or more interrupting signals and a first backoff value associated with a first priority, wherein the first backoff value is based at least in part on a default backoff value, the default backoff value being associated with a default priority; and transmitting a second signal after the second deterministic backoff period.

Aspect 2: The method of aspect 1, wherein a first signal period that includes the first signal comprises one or more transmissions by the first wireless device and zero or more transmissions by zero or more responding wireless devices, and a pair of transmissions is separated by a short interframe space (SIFS) or a point coordination function (PCF) interframe space (PIFS).

Aspect 3: The method of any of aspects 1 through 2, further comprising: transmitting a third signal after a randomized backoff period and before the first deterministic backoff period, the randomized backoff period being based at least in part on detecting a collision pattern including one or more successful transmissions between colliding transmissions, and the monitoring being performed in response to a successful transmission of the third signal.

Aspect 4: The method of any of aspects 1 through 3, wherein the first backoff value is a multiple of the default backoff value or a divisor of the default backoff value.

Aspect 5: The method of any of aspects 1 through 4, further comprising: transmitting a plurality of signals periodically after the second signal in accordance with a ratio between the first priority and the default priority.

Aspect 6: The method of any of aspects 1 through 5, wherein the zero or more interrupting signals are respectively transmitted by one or more second wireless devices of a set of wireless devices, each of the one or more second wireless devices transmits in accordance with one or more respective second backoff values associated with one or more respective priorities, and a transmission cycle of the set of wireless devices is based at least in part on the first backoff value and one or more ratios of the first backoff value to the one or more respective second backoff values.

Aspect 7: The method of any of aspects 1 through 6, wherein the first backoff value and the default backoff value are included in a set of backoff values, and each backoff value is a divisor of a greatest backoff value included in the set of backoff values.

Aspect 8: The method of any of aspects 1 through 7, wherein the first backoff value and the default backoff value are included in a set of backoff values, and each backoff value is a multiple of a smallest backoff value included in the set of backoff values.

Aspect 9: The method of any of aspects 1 through 8, wherein the first backoff value and the default backoff value are included in a set of backoff values, and each backoff value except a smallest backoff value is a multiple of a next smaller backoff value included in the set of backoff values.

Aspect 10: The method of any of aspects 1 through 9, further comprising: detecting a collision pattern based at least in part on a threshold of a quantity of repeated colliding transmissions; and transmitting a third signal after a randomized backoff period and before the first deterministic backoff period in response to detecting the collision pattern.

Aspect 11: The method of aspect 10, wherein the randomized backoff period is based at least in part on a random value within a random range and an offset value.

Aspect 12: The method of aspect 11, wherein the offset value is determined in accordance with a function that increases with the quantity of repeated colliding transmissions.

Aspect 13: The method of aspect 12, wherein the function comprises a block size value, indicating a quantity of time for increasing the first backoff value, multiplied by a difference between the quantity of repeated colliding transmissions and a minimum quantity of repeated colliding transmissions to trigger the randomized backoff period.

Aspect 14: The method of aspect 13, wherein the block size value is a random quantity within a range that increases with the quantity of repeated colliding transmissions.

Aspect 15: The method of any of aspects 12 through 14, wherein the function increases linearly, increases exponentially, is limited to a range within a maximum value, or a combination thereof.

Aspect 16: A method for wireless communications by a first wireless device, comprising: monitoring a wireless channel to detect a collision pattern; transmitting a first signal after a randomized backoff period in response to detecting the collision pattern, the randomized backoff period being based at least in part on a random value within a random range and an offset value; monitoring the wireless channel during a first deterministic backoff period after the first signal to identify a first quantity of zero or more interrupting signals; transmitting, after the first deterministic backoff period, a second signal, the second signal followed by a second deterministic backoff period that is based at least in part on the first quantity of the zero or more interrupting signals and a first backoff value; and transmitting a third signal after the second deterministic backoff period.

Aspect 17: The method of aspect 16, further comprising: detecting the collision pattern based at least in part on a threshold of a quantity of repeated colliding transmissions.

Aspect 18: The method of aspect 17, wherein the offset value is determined in accordance with a function that increases with the quantity of repeated colliding transmissions.

Aspect 19: The method of aspect 18, wherein the function comprises a block size value, indicating a quantity of time for increasing the first backoff value, multiplied by a difference between the quantity of repeated colliding transmissions and a minimum quantity of colliding transmissions to trigger the randomized backoff period.

Aspect 20: The method of aspect 19, wherein the block size value is a random quantity within a range that increases with the quantity of colliding transmissions.

Aspect 21: The method of any of aspects 18 through 20, wherein the function increases linearly, increases exponentially, is limited to a range within a maximum value, or a combination thereof.

Aspect 22: A first wireless device comprising one or more memories storing processor-executable code, and one or more processors coupled with the one or more memories and individually or collectively operable to execute the code to cause the first wireless device to perform a method of any of aspects 1 through 15.

Aspect 23: A first wireless device comprising at least one means for performing a method of any of aspects 1 through 15.

Aspect 24: A non-transitory computer-readable medium storing code the code comprising instructions executable by a processor to perform a method of any of aspects 1 through 15.

Aspect 25: A first wireless device comprising one or more memories storing processor-executable code, and one or more processors coupled with the one or more memories and individually or collectively operable to execute the code to cause the first wireless device to perform a method of any of aspects 16 through 21.

Aspect 26: A first wireless device comprising at least one means for performing a method of any of aspects 16 through 21.

Aspect 27: A non-transitory computer-readable medium storing code the code comprising instructions executable by a processor to perform a method of any of aspects 16 through 21.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some implementations be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless device, comprising:
one or more memories storing processor-executable code; and
one or more processors coupled with the one or more memories and individually or collectively operable to execute the code to cause the first wireless device to:
monitor a wireless channel during a first deterministic backoff period to identify a first quantity of zero or more interrupting signals;
transmit, after the first deterministic backoff period, a first signal, the first signal followed by a second deterministic backoff period that is based at least in part on the first quantity of the zero or more interrupting signals and a first backoff value associated with a first priority,
wherein the first backoff value is based at least in part on a default backoff value, the default backoff value being associated with a default priority; and
transmit a second signal after the second deterministic backoff period.

2. The first wireless device of claim 1, wherein:
a first signal period that includes the first signal comprises one or more transmissions by the first wireless device and zero or more transmissions by zero or more responding wireless devices, and
a pair of transmissions is separated by a short interframe space (SIFS) or a point coordination function (PCF) interframe space (PIFS).

3. The first wireless device of claim 1, wherein the one or more processors are individually or collectively further operable to execute the code to cause the first wireless device to:
transmit a third signal after a randomized backoff period and before the first deterministic backoff period, the randomized backoff period being based at least in part on a collision pattern including one or more successful transmissions between colliding transmissions being detected, and the wireless channel being monitored in response to a successful transmission of the third signal.

4. The first wireless device of claim 1, wherein the first backoff value is a multiple of the default backoff value or a divisor of the default backoff value.

5. The first wireless device of claim 1, wherein the one or more processors are individually or collectively further operable to execute the code to cause the first wireless device to:
transmit a plurality of signals periodically after the second signal in accordance with a ratio between the first priority and the default priority.

6. The first wireless device of claim 1, wherein:
the zero or more interrupting signals are respectively transmitted by one or more second wireless devices of a set of wireless devices,
each of the one or more second wireless devices transmits in accordance with one or more respective second backoff values associated with one or more respective priorities, and
a transmission cycle of the set of wireless devices is based at least in part on the first backoff value and one or more ratios of the first backoff value to the one or more respective second backoff values.

7. The first wireless device of claim 1, wherein:
the first backoff value and the default backoff value are included in a set of backoff values, and
each backoff value is a divisor of a greatest backoff value included in the set of backoff values.

8. The first wireless device of claim 1, wherein:
the first backoff value and the default backoff value are included in a set of backoff values, and
each backoff value is a multiple of a smallest backoff value included in the set of backoff values.

9. The first wireless device of claim 1, wherein:
the first backoff value and the default backoff value are included in a set of backoff values, and
each backoff value except a smallest backoff value is a multiple of a next smaller backoff value included in the set of backoff values.

10. The first wireless device of claim 1, wherein the one or more processors are individually or collectively further operable to execute the code to cause the first wireless device to:
detect a collision pattern based at least in part on a threshold of a quantity of repeated colliding transmissions; and
transmit a third signal after a randomized backoff period and before the first deterministic backoff period in response to detecting the collision pattern.

11. The first wireless device of claim 10, wherein the randomized backoff period is based at least in part on a random value within a random range and an offset value.

12. The first wireless device of claim 11, wherein the offset value is determined in accordance with a function that increases with the quantity of repeated colliding transmissions.

13. The first wireless device of claim 12, wherein the function comprises a block size value, indicating a quantity of time for increasing the first backoff value, multiplied by a difference between the quantity of repeated colliding transmissions and a minimum quantity of repeated colliding transmissions to trigger the randomized backoff period.

14. The first wireless device of claim 13, wherein the block size value is a random quantity within a range that increases with the quantity of repeated colliding transmissions.

15. A first wireless device, comprising:
one or more memories storing processor-executable code; and
one or more processors coupled with the one or more memories and individually or collectively operable to execute the code to cause the first wireless device to:
monitor a wireless channel to detect a collision pattern;
transmit a first signal after a randomized backoff period in response to detecting the collision pattern, the randomized backoff period being based at least in part on a random value within a random range and an offset value;
monitor the wireless channel during a first deterministic backoff period after the first signal to identify a first quantity of zero or more interrupting signals;
transmit, after the first deterministic backoff period, a second signal, the second signal followed by a second deterministic backoff period that is based at least in part on the first quantity of the zero or more interrupting signals and a first backoff value; and
transmit a third signal after the second deterministic backoff period.

16. The first wireless device of claim 15, wherein the one or more processors are individually or collectively further operable to execute the code to cause the first wireless device to:
detect the collision pattern based at least in part on a threshold of a quantity of repeated colliding transmissions.

17. The first wireless device of claim 16, wherein the offset value is determined in accordance with a function that increases with the quantity of repeated colliding transmissions.

18. The first wireless device of claim 17, wherein the function comprises a block size value, indicating a quantity of time for increasing the first backoff value, multiplied by a difference between the quantity of repeated colliding transmissions and a minimum quantity of collisions to trigger the randomized backoff period.

19. The first wireless device of claim 18, wherein the block size value is a random quantity within a range that increases with the quantity of collisions.

20. The first wireless device of claim 17, wherein the function increases linearly, increases exponentially, is limited to a range within a maximum value, or a combination thereof.

21. A method for wireless communications by a first wireless device, comprising:
monitoring a wireless channel during a first deterministic backoff period to identify a first quantity of zero or more interrupting signals;
transmitting, after the first deterministic backoff period, a first signal, the first signal followed by a second deterministic backoff period that is based at least in part on the first quantity of the zero or more interrupting signals and a first backoff value associated with a first priority, wherein the first backoff value is based at least in part on a default backoff value, the default backoff value being associated with a default priority; and
transmitting a second signal after the second deterministic backoff period.

22. The method of claim 21, further comprising:
transmitting a third signal after a randomized backoff period and before the first deterministic backoff period, the randomized backoff period being based at least in part on detecting a collision pattern including one or more successful transmissions between colliding transmissions, and the monitoring being performed in response to a successful transmission of the third signal.

23. The method of claim 21, wherein the first backoff value is a multiple of the default backoff value or a divisor of the default backoff value.

24. The method of claim 21, further comprising:
transmitting a plurality of signals periodically after the second signal in accordance with a ratio between the first priority and the default priority.

25. The method of claim 21, further comprising:
detecting a collision pattern based at least in part on a threshold of a quantity of repeated colliding transmissions; and
transmitting a third signal after a randomized backoff period and before the first deterministic backoff period in response to detecting the collision pattern.

26. A method for wireless communications by a first wireless device, comprising:
monitoring a wireless channel to detect a collision pattern;
transmitting a first signal after a randomized backoff period in response to detecting the collision pattern, the randomized backoff period being based at least in part on a random value within a random range and an offset value;
monitoring the wireless channel during a first deterministic backoff period after the first signal to identify a first quantity of zero or more interrupting signals;
transmitting, after the first deterministic backoff period, a second signal, the second signal followed by a second deterministic backoff period that is based at least in part on the first quantity of the zero or more interrupting signals and a first backoff value; and
transmitting a third signal after the second deterministic backoff period.

27. The method of claim 26, further comprising:
detecting the collision pattern based at least in part on a threshold of a quantity of repeated colliding transmissions.

28. The method of claim 27, wherein the offset value is determined in accordance with a function that increases with the quantity of repeated colliding transmissions.

29. The method of claim 28, wherein the function comprises a block size value, indicating a quantity of time for increasing the first backoff value, multiplied by a difference between the quantity of repeated colliding transmissions and a minimum quantity of collisions to trigger the randomized backoff period.

30. The method of claim 29, wherein the block size value is a random quantity within a range that increases with the quantity of collisions.
